(19) United States
(12) Patent Application Publication
(10) Pub. No.: US 2026/0160966 A1
(43) Pub. Date: Jun. 11, 2026

(54) DYNAMIC ALIGNMENT OF OPTICAL FIBERS WITH A PHOTONIC INTEGRATED CIRCUIT

(71) Applicant: Lightmatter, Inc., Boston, MA (US)

(72) Inventors: Omkar Karhade, Chandler, AZ (US); Vamsi Chandra Meesala, Laveen, AZ (US)

(73) Assignee: Lightmatter, Inc., Boston, MA (US)

(21) Appl. No.: 19/413,216

(22) Filed: Dec. 9, 2025

Related U.S. Application Data
(60) Provisional application No. 63/730,393, filed on Dec. 10, 2024.

(51) Int. Cl. G02B 6/42

(52) U.S. Cl. CPC G02B 6/4286

(57) ABSTRACT

Described herein are packaged photonic devices configured to mitigate the negative effects of package warpage using piezoelectric transducers. As the package deforms due to mismatches in the coefficient of thermal expansion (CTE) among its components, the piezoelectric transducers are actuated to bend and conform to the resulting curvature of the photonic integrated circuit (PIC). By adapting their shape to the warped surface, the piezoelectric transducers restore and maintain proper optical alignment, thereby ensuring efficient fiber-to-PIC coupling despite the presence of package warpage. In one example, a photonic device comprises a PIC, an optical assembly attached to the PIC and comprising a fiber array unit (FAU) and a fiber array attached to the FAU, and a piezoelectric transducer attached to the FAU.

### CROSS-REFERENCE TO RELATED APPLICATION

This application claims the benefit of U.S. Provisional Application Ser. No. 63/730,393, filed on Dec. 10, 2024, under Attorney Docket No. L0858.70110US00 and entitled “DYNAMIC ALIGNMENT OF OPTICAL FIBERS WITH A PHOTONIC INTEGRATED CIRCUIT,” which is hereby incorporated herein by reference in its entirety.

### BACKGROUND

Optical communication networks are experiencing a significant increase in data traffic bandwidth requirements, driving the need for higher channel counts and increased complexity embedded within photonic integrated circuits (PICs). This has led to larger PIC footprints and the use of through-silicon vias (TSVs), often reducing the PIC thickness to around 0.1 millimeters. The larger footprint and reduced thickness contribute to PIC packaging challenges.

### BRIEF SUMMARY

In some aspects, the techniques described herein relate to a photonic device, including: a photonic integrated circuit (PIC); an optical assembly, attached to the PIC, including a fiber array unit (FAU) and a fiber array attached to the FAU; and a piezoelectric transducer attached to the FAU.

In some aspects, the techniques described herein relate to a photonic device, wherein the FAU includes a flexible organic material.

In some aspects, the techniques described herein relate to a photonic device, wherein the FAU is less than 50 μm in thickness.

In some aspects, the techniques described herein relate to a photonic device, further including a power source, wherein: the piezoelectric transducer includes a pair of electrodes, and the power source is coupled to the pair of electrodes.

In some aspects, the techniques described herein relate to a photonic device, further including a substrate, wherein the PIC and the power source are disposed on the substrate, and the power source is coupled to the pair of electrodes via wire bonds.

In some aspects, the techniques described herein relate to a photonic device, wherein the FAU includes a first surface near the substrate and a second surface away from the substrate, wherein the piezoelectric transducer is attached to the second surface.

In some aspects, the techniques described herein relate to a photonic device, further including: a waveguide integrated with the PIC; a detector optically coupled to the waveguide and configured to detect a power level of light present in the waveguide; and a controller configured to control the power source based on the detected power level.

In some aspects, the techniques described herein relate to a photonic device, wherein the fiber array includes between 16 and 128 fibers attached to the FAU.

In some aspects, the techniques described herein relate to a photonic device, further including a plurality of application-specific integrated circuits (ASICs), wherein the PIC includes optical switches configured to route data traffic among the plurality of ASICs.

In some aspects, the techniques described herein relate to a photonic device, including: a photonic integrated circuit (PIC); an optical assembly, attached to the PIC, including a fiber array unit (FAU) and a fiber array attached to the FAU; and a piezoelectric transducer attached to the PIC.

In some aspects, the techniques described herein relate to a photonic device, further including a power source, wherein: the piezoelectric transducer includes a pair of electrodes, and the power source is coupled to the pair of electrodes.

In some aspects, the techniques described herein relate to a photonic device, further including a substrate, wherein the PIC and the power source are disposed on the substrate, and the power source is coupled to the pair of electrodes via wire bonds.

In some aspects, the techniques described herein relate to a photonic device, wherein the PIC includes a first surface near the substrate and a second surface away from the substrate, wherein the piezoelectric transducer is attached to the second surface.

In some aspects, the techniques described herein relate to a photonic device, further including: a waveguide integrated with the PIC; a detector optically coupled to the waveguide and configured to detect a power level of light present in the waveguide; and a controller configured to control the power source based on the detected power level.

In some aspects, the techniques described herein relate to a photonic device, wherein the fiber array includes between 16 and 128 fibers attached to the FAU.

In some aspects, the techniques described herein relate to a photonic device, further including a plurality of application-specific integrated circuits (ASICs), wherein the PIC includes optical switches configured to route data traffic among the plurality of ASICs.

In some aspects, the techniques described herein relate to a method for controlling a photonic package, the method including: attaching an optical assembly to a photonic integrated circuit (PIC), the optical assembly including a fiber array unit (FAU) and a fiber array attached to the FAU; detecting a power level of light present in a waveguide of the PIC; and controlling a piezoelectric transducer attached to the FAU to deform the FAU using the detected power level.

In some aspects, the techniques described herein relate to a method, wherein attaching the optical assembly to the PIC includes attaching the optical assembly to an edge of the PIC.

In some aspects, the techniques described herein relate to a method, wherein monitoring the power level of the light present in the waveguide is performed using a detector optically coupled to the waveguide via a tap coupler.

In some aspects, the techniques described herein relate to a method, wherein the light is encoded with digital data.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A is a perspective exploded view of a packaged photonic device including a substrate, a photonic integrated circuit (PIC), multiple fiber arrays and multiple application-specific integrated circuits (ASICs), in accordance with some embodiments.

FIG. 1B is a top view illustrating a portion of the PIC of FIG. 1A, in accordance with some embodiments.

FIG. 2A is a side view of the packaged photonic device of FIG. 1A in the presence of package warpage, in accordance with some embodiments.

FIG. 2B is a side view illustrating the vertical displacement of the PIC's waveguides relative to a fiber array in the presence of package warpage, in accordance with some embodiments.

FIG. 3A is a side view illustrating an example of a piezoelectric transducer, in accordance with some embodiments.

FIG. 3B illustrates a piezoelectric transducer exhibiting symmetric deformation, in accordance with some embodiments.

FIG. 3C illustrates a piezoelectric transducer exhibiting asymmetric deformation, in accordance with some embodiments.

FIGS. 4A-4B are side views of a packaged photonic device including piezoelectric transducers, in accordance with some embodiments. FIG. 4A illustrates a scenario in which the piezoelectric transducers are at rest; FIG. 4B illustrates a scenario in which the piezoelectric transducers are deformed.

FIG. 4C is a side view illustrating the re-alignment of the fibers and the corresponding waveguides using piezoelectric transducers, in accordance with some embodiments.

FIG. 5 is a side view of a packaged photonic device having a piezoelectric transducer configured to counteract and reduce the warpage of a PIC, in accordance with some embodiments.

FIG. 6 is a block diagram illustrating a feedback loop configured to actively control a piezoelectric transducer, in accordance with some embodiments.

### DETAILED DESCRIPTION

Described herein are packaged photonic devices configured to mitigate the negative effects of package warpage using piezoelectric transducers. As the package deforms due to mismatches in the coefficient of thermal expansion (CTE) among its components, piezoelectric transducers are actuated to bend and conform to the resulting curvature of the photonic integrated circuit (PIC). By adapting their shape to the warped surface, the piezoelectric transducers restore and maintain proper optical alignment, thereby ensuring efficient fiber-to-PIC coupling despite the presence of package warpage.

One of the critical challenges in PIC packaging is the ability to reliably couple optical fibers to the PIC, as efficient coupling directly affects the overall performance of the device. Misalignment between fibers and on-chip waveguides can lead to significant insertion loss, which in turn degrades power budget, and as a result, system performance. Traditional fiber-to-PIC coupling techniques often rely on pre-manufactured fiber array units (FAUs), optical assemblies that hold multiple fibers in a fixed configuration. As an FAU is attached to the PIC's coupling surface, the individual fibers naturally align with the corresponding waveguides of the PIC, enabling simultaneous coupling of multiple fibers. However, FAUs have become increasingly costly and difficult to implement as fiber counts increase.

PICs are often used as optical interposers. In these architectures, multiple application-specific integrated circuits (ASICs) are co-packaged with, or directly mounted on, a PIC, and the PIC performs data routing and switching among the ASICs in the optical domain. To support these capabilities, the PIC may be equipped with controllable optical switches, devices that can be actively driven to direct optical signals along selected paths, thereby enabling dynamic traffic steering among the ASICs.

The inventors have recognized and appreciated that, in a typical ASIC-on-PIC construction where multiple FAUs are attached to the sides of the PIC, the PIC die can warp during FAU attachment because of CTE mismatch within the stack. FAUs are manufactured to be planar, with the fibers lying in a single plane. As a result, it can be difficult (or even impossible) to actively align a planar FAU to a warped PIC edge. Even if the fibers are optimally aligned, fibers near the center of the FAU will be misaligned due to the bowing of the PIC, resulting in degraded fiber-to-waveguide alignment and increased insertion loss. A conventional solution is to reduce the number of fibers in each FAU. However, this approach is contrary to the goal of increasing channel counts in modern optical communication systems.

The inventors have recognized and appreciated that these effects can be mitigated using piezoelectric transducers. The piezoelectric effect is a phenomenon by which certain materials (referred to as piezoelectric materials) undergo mechanical deformation when an electric field is applied, and conversely, generate electric charge when subjected to mechanical stress. In other words, the same material converts mechanical energy to electrical energy and vice versa. A piezoelectric transducer is a device that is made of (or at least includes) a piezoelectric material.

The piezoelectric transducers developed by the inventors and described herein are designed to maintain proper alignment between an FAU and a PIC in the presence of warpage. This can be achieved in two ways: 1) by actuating the piezoelectric transducer to bend the FAU so that the curvature of the FAU matches the curvature of the PIC, or 2) by actuating the piezoelectric transducer to counteract and reduce the warpage of the PIC itself. In either case, alignment between individual fibers of the FAU and the corresponding waveguides of the PIC is improved, thereby reducing insertion loss.

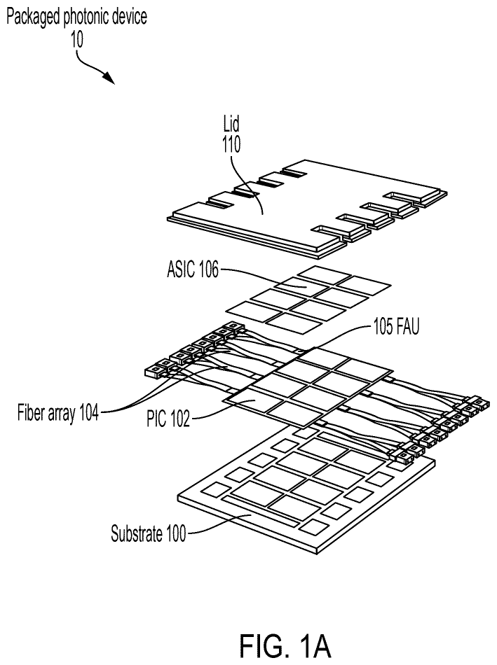

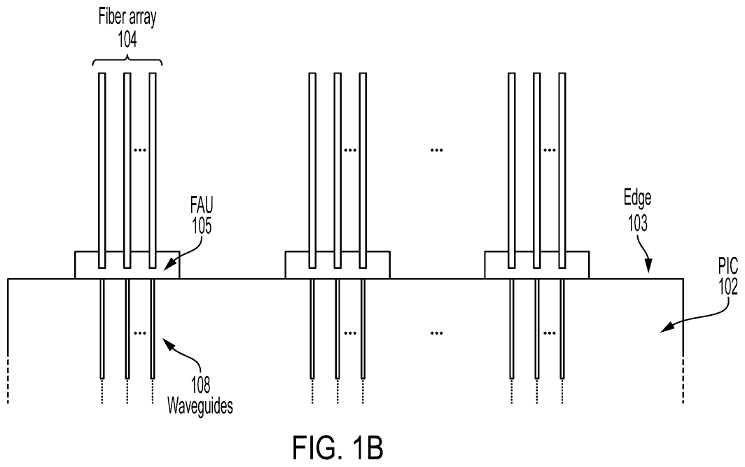

FIG. 1A is a perspective exploded view of a packaged photonic device 10, in accordance with some embodiments. Packaged photonic device 10 includes a substrate 100, a photonic integrated circuit (PIC) 102, multiple fiber arrays 104, multiple application-specific integrated circuits (ASICs) 106 and a lid 110. Substrate 100 may be a printed circuit board (PCB) or an organic substrate, for example. Substrate 100 is configured to route signals generated inside the package to external devices and vice versa. PIC 102 is disposed on substrate 100, whether directly or through intervening layers (e.g., a redistribution layer or an electrical interposer). PIC 102 may be active in nature in that it may include modulators, photodetectors, lasers and/or optical switches. PIC 102 may further include a network of on-chip waveguides. In some embodiments, PIC 102 is made of silicon, and the on-chip waveguides may be made of silicon or silicon nitride.

Packaged photonic device 10 further includes multiple fiber arrays 104 attached to PIC 102. FIG. 1B is a top view illustrating the optical coupling region of PIC 102 in additional detail. Each fiber array 104 includes multiple optical fibers. The ends of the fibers of an array are assembled together using a fiber array unit (FAU) 105. Each FAU 105 holds the fibers of an array in a fixed configuration, constraining the spacing between fibers to match the spacing between on-chip waveguides 108. As a result, all the fibers of an array 104 are simultaneously aligned to corresponding waveguides 108. In one example, an FAU 105 includes an array of V-grooves or U-grooves-V-shaped or U-shaped channels that have been etched on a substrate to hold fibers in place. In the example of FIG. 1B, several FAUs are attached to the same edge (edge 103) of PIC 102. Additional FAUs may be attached to the other edges of the PIC, including to the edge that is opposite to edge 103 (as shown in FIG. 1A).

Referring back to FIG. 1A, multiple ASICs 106 are mounted on PIC 102. Each ASIC may include processing circuitry and/or memory circuitry, for example. The processing circuitry may be implemented as a central processing unit (CPU), a graphic processing unit (GPU), a field programmable gate array (FPGA), an accelerator, etc. The memory circuitry may be implemented as a high-bandwidth memory (HBM), for example. Collectively, the ASICs form a computer system including multiple processing units and multiple memory devices that are optically interconnected with one another via PIC 102.

Packaged photonic device 10 further includes a lid 110. Lid 110 may serve as a protective cover enclosing the dies of packaged photonic device 10. For example, lid 110 may shield the chips from dust and moisture. Additionally, lid 110 may serve as a heat spreader, dissipating heat generated inside the package.

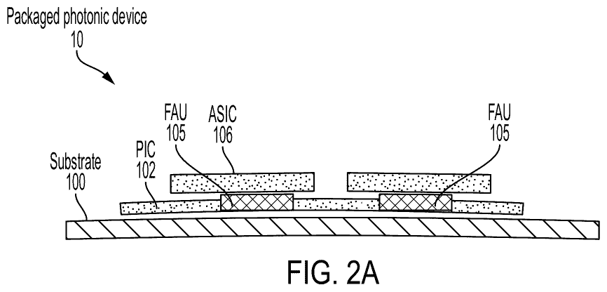

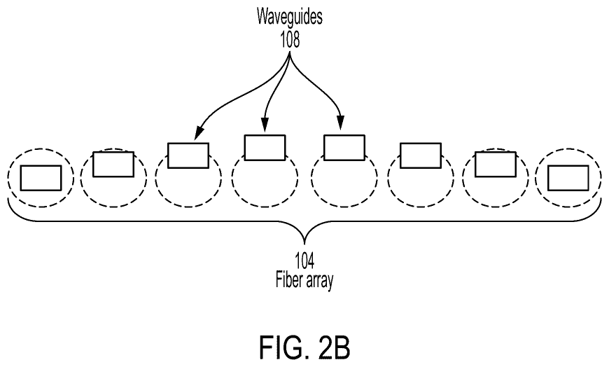

FIG. 2A is a side view of the packaged photonic device of FIG. 1A in the presence of package warpage. Package warpage may occur during FAU attachment because of the CTE mismatch between PIC 102 and substrate 100 and/or because of the CTE mismatch between PIC 102 and other components of photonic device 10. The process of attaching an FAU to a PIC often involves elevated temperatures, for example during the process of curing epoxy. As temperature increases, the extent to which PIC 102 expands differs from the extent to which substrate 100 expands due to CTE mismatch. This creates mechanical stress, ultimately leading to warpage of PIC 102. The result is that the shape of PIC 102 exhibits a curved profile. The non-planar shape of PIC 102 negatively affects the optical alignment between the fibers of an array and the corresponding PIC waveguides. This effect is depicted in FIG. 2B. As shown, the non-planar shape of PIC 102 results in a vertical displacement of some of the waveguides 108 relative to their intended position. This example illustrates waveguides positioned near the center of PIC 102. In FIG. 2B, the displacement has been exaggerated for purposes of illustration. As shown, waveguides that are closer to the center of PIC 102 exhibit a greater vertical displacement, while waveguides that are closer to the edges of PIC 102 exhibit a lesser vertical displacement. This results in varying misalignment between the fibers of array 104 and the corresponding waveguides 108.

To mitigate this effect, the packaged photonic devices developed by the inventors and described herein use piezoelectric transducers. In some embodiments, piezoelectric transducers are actuated to bend an FAU so that the curvature of the FAU matches the curvature of the PIC. Additionally, or alternatively, piezoelectric transducers are actuated to counteract and reduce the warpage of the PIC itself. In either case, alignment between individual fibers of the FAU and the corresponding waveguides of the PIC is improved, thereby reducing insertion loss.

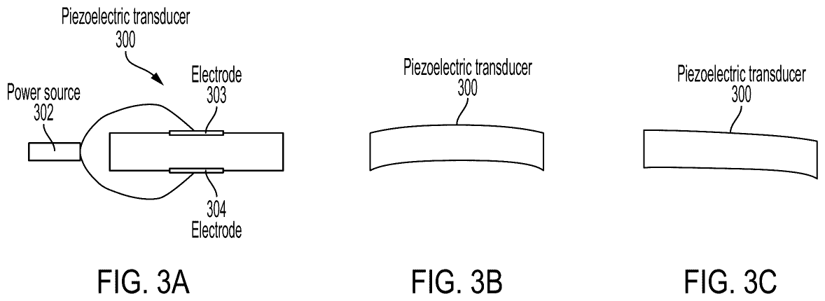

FIG. 3A is a side view illustrating an example of a piezoelectric transducer 300, in accordance with some embodiments. In this example, piezoelectric transducer 300 is in the shape of a strip of piezoelectric material, although other shapes are also possible. A power source 302 is electrically connected to a pair of electrodes (303, 304) of piezoelectric transducer 300, for example using wire bonds. Power source 302 may be disposed on substrate 100. Application of a voltage using power source 302 produces an electric field that traverses piezoelectric transducer 300, thereby triggering the piezoelectric effect. The scenario of FIG. 3A illustrates piezoelectric transducer 300 at rest. No electric field is applied to it, and as result piezoelectric transducer 300 has a planar shape. When an electric field is applied, piezoelectric transducer 300 deforms due to the piezoelectric effect. Piezoelectric transducer 300 may deform in different ways. FIGS. 3B-3C illustrate two alternative scenarios (for clarity of illustration, power source 302 is omitted from these figures). In the scenario of FIG. 3B, deformation of transducer 300 is such that its central portion is raised relative to the edges. This scenario is referred to as symmetric deformation. In the configuration of FIG. 3C, deformation of transducer 300 is such that one of the edges is raised relative to the opposing edge. This scenario is referred to as asymmetric deformation. Whether piezoelectric transducer 300 exhibits symmetric or asymmetric deformation may depend on the distribution of the piezoelectric material across the lateral extension of piezoelectric transducer 300 and/or on the direction and the distribution of the electric field. In some embodiments, a piezoelectric transducer arranged to deform as shown in FIG. 3B may be used to compensate for PIC warpage near the center of the PIC. By contrast, a piezoelectric transducer arranged to deform as shown in FIG. 3C may be used to compensate for PIC warpage further away from the center of the PIC.

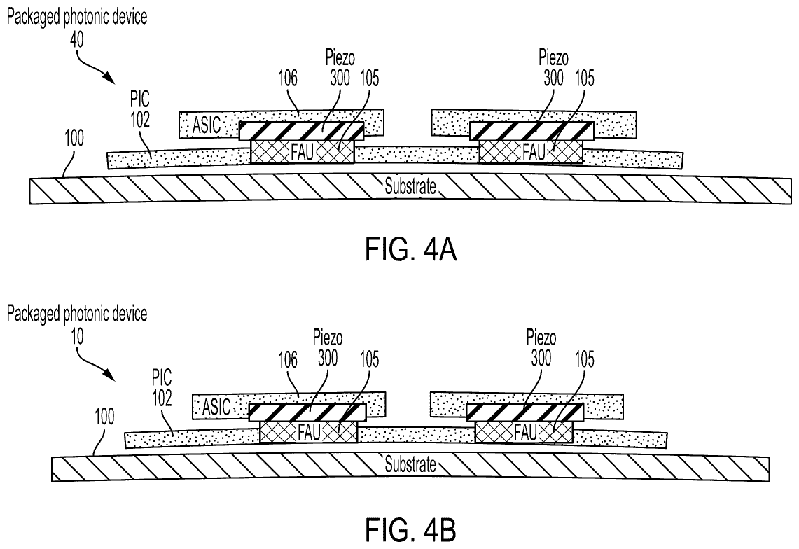

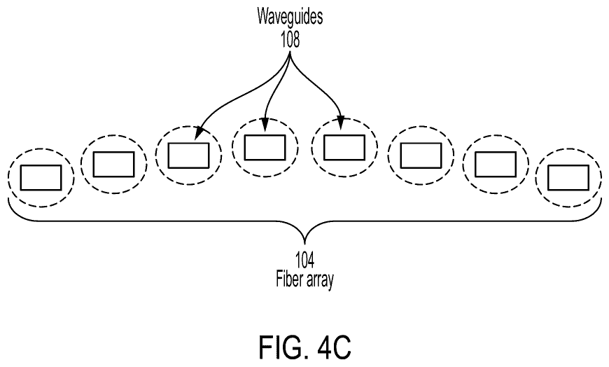

FIGS. 4A-4B are side views of a packaged photonic device 40 including multiple piezoelectric transducers 300 (labelled “piezo” for short), in accordance with some embodiments. Similar to the depiction of FIG. 2A, PIC 102 is warped. As shown, each piezoelectric transducer 300 is attached to an FAU 105. In the example of FIGS. 4A-4B, the piezoelectric transducers 300 are attached to the top surfaces of the FAUs (the surfaces of the FAUs away from substrate 100). Alternatively, the piezoelectric transducers 300 may be attached to the bottom surfaces of the FAUs (the surfaces of the FAUs closer to substrate 100). The piezoelectric transducers may be attached to the FAUs using glue, epoxy or other types of adhesive materials. To facilitate bending, the FAUs may be formed using a flexible organic material and/or may be shaped with a relatively thin profile (e.g., less than 50 μm in thickness, less than 40 μm, less than 30 μm, less than 20 μm or less than 10 μm).

FIG. 4A illustrates a scenario in which the piezoelectric transducers are at rest. No electric fields are applied to piezoelectric transducers 300, which as a result maintain planar shapes. FIG. 4B illustrates a scenario in which piezoelectric transducers 300 are deformed, following the application of electric fields. Because the FAUs are mechanically attached to the piezoelectric transducers, when a piezoelectric transducer deforms, the corresponding FAU also deforms. The piezoelectric transducers are appropriately positioned and arranged to cause the FAUs to conform to the local curvature of PIC 102. FIG. 4C is a side view illustrating the re-alignment of the fibers and the corresponding waveguides using piezoelectric transducers, in accordance with some embodiments. This example illustrates the optical coupling region near the center of PIC 102. To compensate for PIC warpage in this region, piezoelectric transducer 300 is configured to exhibit symmetric deformation, similar to the configuration described above in connection with FIG. 3B. In this scenario, each fiber of array 104 is re-aligned to the corresponding waveguide.

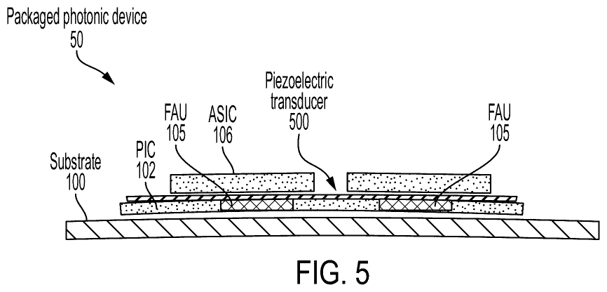

In an alternative arrangement, a piezoelectric transducer may be actuated to counteract and reduce the warpage of the PIC itself. An example implementation of a packaged photonic device 50 configured in this way is depicted in FIG. 5, in accordance with some embodiments. A piezoelectric transducer 500 is attached to PIC 102 (whether to the PIC's top surface as shown in FIG. 5 or to the PIC's bottom surface). The scenario of FIG. 5 illustrates piezoelectric transducer 500 at rest. No electric field is applied to it, and as result piezoelectric transducer 500 conforms to the top surface of PIC 102 (being physically attached to it). When an electric field is applied, piezoelectric transducer 500 deforms due to the piezoelectric effect. Piezoelectric transducer 500 may be oriented to warp with the opposite convexity relative to PIC 102. For example, if warpage of PIC 102 results in the PIC's central portion being raised relative to its edges (as is the case in FIG. 5), piezoelectric transducer 500 may be oriented so that, when an electric field is applied, the transducer's edges are raised relative to the central portion. This effect flattens PIC 102, moving the waveguides back to their intended positions with respect to the vertical direction.

Similar to the arrangement described above in connection with FIG. 3A, a power supply may be used to apply voltage to piezoelectric transducer 500.

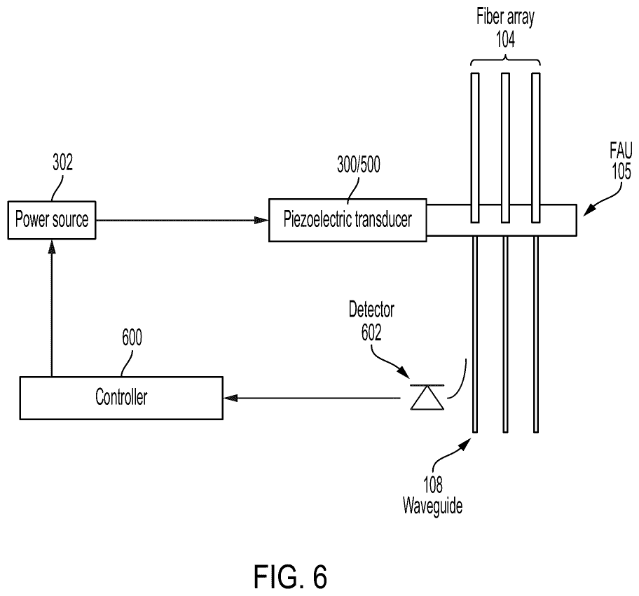

In some embodiments, piezoelectric transducers are actuated during the alignment stage, when the FAUs are attached to the PIC. Additionally or alternatively, the piezoelectric transducers may be actuated during operation of the PIC to compensate for changes in the PIC warpage in real time, as the temperature of the package increases or decreases (e.g., due to heat generated during operation or from changes in the environment). In one example, the piezoelectric transducer may be part of a feedback loop configured to monitor the insertion loss arising at the fiber-to-waveguide coupling region, and to actuate the piezoelectric transducer to restore the optical alignment. FIG. 6 is a block diagram illustrating a feedback loop configured to actively control a piezoelectric transducer, in accordance with some embodiments. The feedback loop includes a detector 602 configured to monitor the power level of light present in a waveguide 108. Detector 602 may be coupled to waveguide 108 via a tap coupler. Based on the detected power level, a controller 600 actively controls power source 302. For example, if the detected power level is within a first range, controller 600 controls power source 302 to generate a first voltage. Application of the first voltage to piezoelectric transducer 300 (or 500) causes a certain degree of deformation. If the detected power level is within a second range (lower than the first range), controller 600 controls power source 302 to generate a second voltage greater than the first voltage. Application of the second voltage to piezoelectric transducer 300 (or 500) causes a greater degree of deformation. More generally, the lower the detected power level, the greater the degree of deformation imparted on piezoelectric transducer 300 (or 500).

This procedure may be performed during operation of the PIC. For example, light traveling in waveguide 108 (of which detector 602 monitors the power level) may be encoded with digital data.

Use of piezoelectric transducers in the manner described herein enables FAUs with a larger number of optical fibers than what is practical using conventional approaches. For example, an FAU may include between 4 and 128 fibers, between 4 and 64 fibers, between 4 and 48 fibers, between 4 and 32 fibers, between 4 and 24 fibers, between 4 and 16 fibers, between 4 and 12 fibers, between 4 and 8 fibers, between 8 and 128 fibers, between 8 and 64 fibers, between 8 and 48 fibers, between 8 and 32 fibers, between 8 and 24 fibers, between 8 and 16 fibers, or between 8 and 12 fibers, between 16 and 128 fibers, between 16 and 64 fibers, between 16 and 48 fibers, between 16 and 32 fibers, between 16 and 24 fibers, between 32 and 128 fibers, between 32 and 64 fibers, or between 32 and 48 fibers, for example.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined term.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within +20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A photonic device, comprising:
a photonic integrated circuit (PIC);
an optical assembly, attached to the PIC, comprising a fiber array unit (FAU) and a fiber array attached to the FAU; and
a piezoelectric transducer attached to the FAU.

2. The photonic device of claim 1, wherein the FAU comprises a flexible organic material.

3. The photonic device of claim 1, wherein the FAU is less than 50 μm in thickness.

4. The photonic device of claim 1, further comprising a power source, wherein:
the piezoelectric transducer comprises a pair of electrodes, and
the power source is coupled to the pair of electrodes.

5. The photonic device of claim 4, further comprising a substrate, wherein the PIC and the power source are disposed on the substrate, and the power source is coupled to the pair of electrodes via wire bonds.

6. The photonic device of claim 5, wherein the FAU comprises a first surface near the substrate and a second surface away from the substrate, wherein the piezoelectric transducer is attached to the second surface.

7. The photonic device of claim 4, further comprising:
a waveguide integrated with the PIC;
a detector optically coupled to the waveguide and configured to detect a power level of light present in the waveguide; and
a controller configured to control the power source based on the detected power level.

8. The photonic device of claim 1, wherein the fiber array comprises between 16 and 128 fibers attached to the FAU.

9. The photonic device of claim 1, further comprising a plurality of application-specific integrated circuits (ASICs), wherein the PIC comprises optical switches configured to route data traffic among the plurality of ASICs.

10. A photonic device, comprising:
a photonic integrated circuit (PIC);
an optical assembly, attached to the PIC, comprising a fiber array unit (FAU) and a fiber array attached to the FAU; and
a piezoelectric transducer attached to the PIC.

11. The photonic device of claim 10, further comprising a power source, wherein:
the piezoelectric transducer comprises a pair of electrodes, and
the power source is coupled to the pair of electrodes.

12. The photonic device of claim 11, further comprising a substrate, wherein the PIC and the power source are disposed on the substrate, and the power source is coupled to the pair of electrodes via wire bonds.

13. The photonic device of claim 12, wherein the PIC comprises a first surface near the substrate and a second surface away from the substrate, wherein the piezoelectric transducer is attached to the second surface.

14. The photonic device of claim 11, further comprising:
a waveguide integrated with the PIC;
a detector optically coupled to the waveguide and configured to detect a power level of light present in the waveguide; and
a controller configured to control the power source based on the detected power level.

15. The photonic device of claim 10, wherein the fiber array comprises between 16 and 128 fibers attached to the FAU.

16. The photonic device of claim 10, further comprising a plurality of application-specific integrated circuits (ASICs), wherein the PIC comprises optical switches configured to route data traffic among the plurality of ASICs.

17. A method for controlling a photonic package, the method comprising:
attaching an optical assembly to a photonic integrated circuit (PIC), the optical assembly comprising a fiber array unit (FAU) and a fiber array attached to the FAU;
detecting a power level of light present in a waveguide of the PIC; and
controlling a piezoelectric transducer attached to the FAU to deform the FAU using the detected power level.

18. The method of claim 17, wherein attaching the optical assembly to the PIC comprises attaching the optical assembly to an edge of the PIC.

19. The method of claim 17, wherein monitoring the power level of the light present in the waveguide is performed using a detector optically coupled to the waveguide via a tap coupler.

20. The method of claim 17, wherein the light is encoded with digital data.
